(19) United States
(12) Patent Application Publication
(10) Pub. No.: US 2026/0368272 A1
(43) Pub. Date: Nov. 19, 2026

(54) PAGE CONTENT EDITING METHOD, APPARATUS, ELECTRONIC DEVICE, STORAGE MEDIUM, AND PROGRAM PRODUCT

(71) Applicant: Beijing Zitiao Network Technology Co., Ltd., Beijing (CN)

(72) Inventors: Jiansong YAN, Beijing (CN); Guangping XIE, Beijing (CN)

(21) Appl. No.: 19/657,738

(22) Filed: Apr. 24, 2026

(30) Foreign Application Priority Data
May 13, 2025 (CN) 202510615013.8

(51) Int. Cl. G06F 16/957; G06F 3/0483; G06F 3/04845

(52) U.S. Cl. CPC G06F 16/9577; G06F 3/0483; G06F 3/04845

(57) ABSTRACT

The present application provides a page content editing method and apparatus, an electronic device, a storage medium, and a program product. When an editing instruction is received from an editing interaction region of a first page, update data and a target identifier corresponding to at least one target page element of a document may be determined, and a document page is controlled to move to a position corresponding to the at least one target page element and the at least one target page element is edited based on the update data.

### CROSS-REFERENCE TO RELATED APPLICATIONS

The present application is based on and claims priority to Chinese Application No. 202510615013.8, filed on May 13, 2025, which is incorporated herein by reference in its entirety.

### TECHNICAL FIELD

The present application relates to the field of computer technology, and in particular, to a page content editing method and apparatus, an electronic device, a storage medium, and a program product.

### BACKGROUND

With the continuous development of artificial intelligence technologies, artificial intelligence (AI) assisted writing tools have gradually become an important way to improve writing efficiency. However, in the process of writing with an AI assisted writing tool, a user cannot intuitively know the real-time progress of data updating in a page generated by the AI assisted writing tool.

### SUMMARY

In view of this, an objective of the present application is to provide a page content editing method and apparatus, an electronic device, a storage medium, and a program product to solve or partially solve the above technical problems.

Based on the above objective, a first aspect of the present application provides a page content editing method, including:
displaying a first page, where the first page includes a document and an editing interaction region;
determining update data and a target identifier in response to receiving an editing instruction from the editing interaction region, where the target identifier corresponds to at least one target page element of the document; and
controlling a document page corresponding to the document to move to a position corresponding to the at least one target page element and editing the at least one target page element based on the update data.

Based on the same inventive concept, a second aspect of the present application provides a page content editing apparatus, including:
a displaying module, configured to display a first page, where the first page includes a document and an editing interaction region;
a determining module, configured to determine update data and a target identifier in response to receiving an editing instruction from the editing interaction region, where the target identifier corresponds to at least one target page element of the document; and
a moving module, configured to control a document page corresponding to the document to move to a position corresponding to the at least one target page element and edit the at least one target page element based on the update data.

Based on the same inventive concept, a third aspect of the present application provides an electronic device, including a memory, a processor, and a computer program stored in the memory and executable by the processor, where the computer program, when executed by the processor, implements the method according to the first aspect.

Based on the same inventive concept, a fourth aspect of the present application provides a computer-readable storage medium, storing computer instructions, where the computer instructions are configured to cause a computer to execute the method according to the first aspect.

Based on the same inventive concept, a fifth aspect of the present application provides a computer program product, including computer program instructions that, when executed on a computer, cause the computer to execute the method according to the first aspect.

It may be seen from the above that according to the page content editing method and apparatus, the electronic device, the storage medium, and the program product provided in the present application, when the editing instruction is received from the editing interaction region of the first page, the update data and the target identifier corresponding to the at least one target page element of the document may be determined, and the document page may be controlled to move to the position corresponding to the target page element and the target page element may be edited based on the update data.

### BRIEF DESCRIPTION OF THE DRAWINGS

In order to more clearly explain the technical solutions in the present application or in the related art, the following briefly introduces the drawings that need to be used in the description of the embodiments or the related art. Obviously, the drawings in the following description are only embodiments of the present application, and for those of ordinary skill in the art, other drawings may also be obtained based on these drawings without creative efforts.

FIG. 1 is a schematic diagram of an application scenario of an embodiment of the present application.

FIG. 2 is a schematic flowchart of a page content editing method according to an embodiment of the present application.

FIG. 3 is a first schematic diagram of an exemplary page according to an embodiment of the present application.

FIG. 4 is a second schematic diagram of an exemplary page according to an embodiment of the present application.

FIG. 5 is a third schematic diagram of an exemplary page according to an embodiment of the present application.

FIG. 6 is a structural block diagram of a page content editing apparatus according to an embodiment of the present application.

FIG. 7 is a schematic diagram of a hardware structure of an electronic device according to an embodiment of the present application.

### DETAILED DESCRIPTION OF EMBODIMENTS

It may be understood that the data involved in the technical solution (including but not limited to the data itself, acquisition or use of the data) should comply with requirements of corresponding laws, regulations, and related provisions.

The principles and spirit of the present application are described below with reference to several exemplary implementations. It should be understood that these implementations are provided only for those skilled in the art to better understand and implement the present application, but not to limit the scope of the present application in any way. On the contrary, these implementations are provided to make the present application more thorough and complete, and to fully convey the scope of the present application to those skilled in the art.

It may be understood that before the use of the technical solutions in the embodiments of the present application, the user will be informed of the type, range of use, use scenarios, etc., of involved personal information in an appropriate manner, and the authorization of the user will be obtained.

For example, in response to receiving an active request from a user, prompt information is sent to the user to clearly inform the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present application.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying and obtaining user authorization is only illustrative and does not constitute a limitation on the implementations of the present application, and other manners that satisfy the relevant laws and regulations may also be applied in the implementations of the present application.

In the present application, it should be understood that any number of elements in the drawings is for illustration rather than limitation, and any names are only for distinction rather than limitation.

The principles and spirit of the present application are explained in detail below with reference to several representative implementations of the present application.

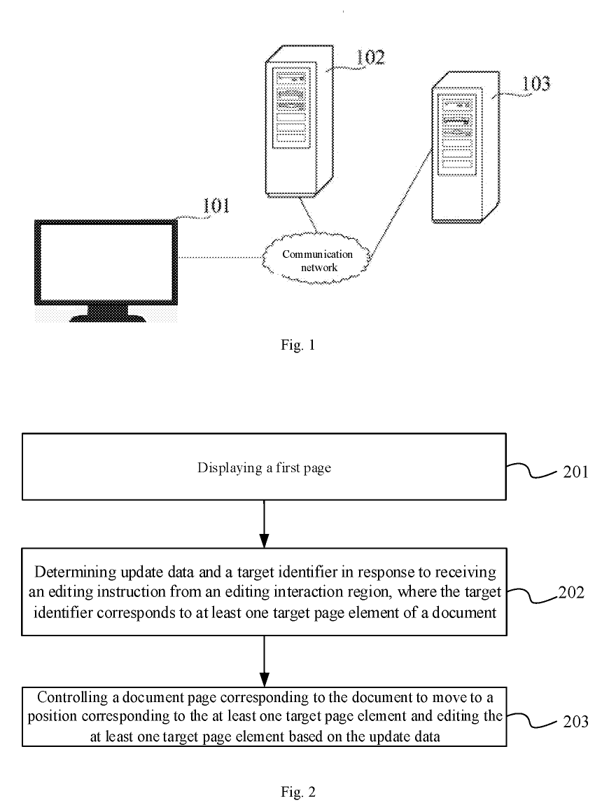

Reference is made to FIG. 1, which is a schematic diagram of an application scenario of a page content editing method provided by an embodiment of the present application. The application scenario may include a terminal device 101, a server 102, and a data storage system 103. The terminal device 101, the server 102, and the data storage system 103 may all be connected to each other through a wired or wireless communication network. The terminal device 101 includes but is not limited to a desktop computer, a mobile phone, a mobile computer, a tablet computer, a media player, a smart wearable device, a personal digital assistant (PDA), or other electronic devices capable of implementing the above functions. The server 102 and the data storage system 103 may each be an independent physical server, a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, CDNs, and big data and artificial intelligence platforms.

As an exemplary application scenario, a user may perform an editing operation on a document in an editing interaction region of a first page through the terminal device 101, determine update data and a target identifier through the terminal device 101, and then control a document page in the first page to scroll to a position corresponding to a target page element corresponding to the target identifier and edit the target page element based on the update data. Optionally, when at least a part of the steps of the scenario cannot be performed by the terminal device 101 alone, the terminal device 101 may generate a corresponding request and send the request to the server 102, and the server 102 performs the corresponding steps and returns the result to the terminal device 101. The data storage system 103 may provide data storage support for the operation of the server 102 and the corresponding terminal device 101, for example, for storing running program codes, at least one page element, and a corresponding identifier generated for each page element, and so on.

The page content editing method according to the exemplary implementations of the present application is described below in conjunction with the application scenario of FIG. 1. It should be noted that the above application scenario is only shown to facilitate understanding of the spirit and principles of the present application, and the implementations of the present application are not limited in this regard. On the contrary, the implementations of the present application may be applied to any applicable scenario.

An embodiment of the present application provides a page content editing method. As shown in FIG. 2, the method includes:
Step 201: displaying a first page.
In this step, the first page may be displayed by an editing application or software in the terminal device 101, and a specific cloud document may be opened in the editing application or software so that the document is displayed in the first page.

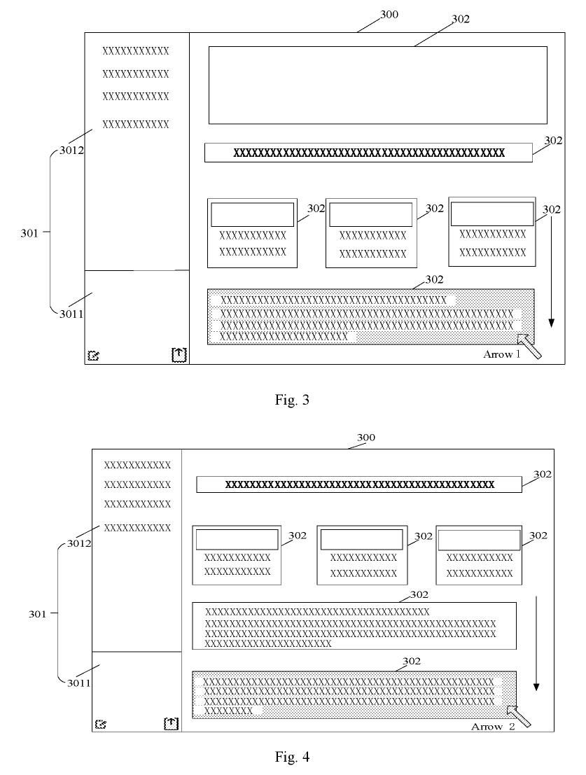

In some embodiments, the first page may include a document and an editing interaction region. For example, as shown in FIG. 3, a right region of a first page 300 may be a document page for displaying the document, the document is displayed therein, and a left region 301 of the first page 300 may be an editing interaction region for the user to perform an editing interaction operation.

The editing interaction region may refer to an interface region where the user interacts with the document, for example, an interface where the user interacts with the document through operations such as clicking, dragging, and inputting. When the user performs an operation in the editing interaction region, such as inputting text or voice information, an editing instruction is formed.

In some embodiments, the editing interaction region is configured to implement interaction by a conversational manner. In other words, the editing interaction region allows the user to implement interaction by chatting and to generate the editing instruction by chatting, thereby improving operation experience.

Optionally, as shown in FIG. 3, the editing interaction region 301 may include a conversation region 3012 and an input region 3011. The user may input content in the input region 3011 to generate the editing instruction. For example, the user may input content in the input region 3011 and then send the content (for example, click a sending control or tap the Enter key on an external keyboard) to the conversation region 3012, thereby triggering the terminal device 101 to generate the editing instruction based on the content input in the input region.

Optionally, the conversation region 3012 may include the content input in the input region for generating the editing instruction and reply content generated based on the content, so that interactive content in the form of a conversation may be presented in the first page.

For example, the content input by the user in the input region may be "Please help me replace the text AAAA in the document with BBBB", and the content is sent to the conversation region 3012. The terminal device 101 may generate corresponding reply content based on the content, for example, "Okay, I will replace the text AAAA in the document with BBBB for you", and the reply content may be displayed in the conversation region 3012 (for example, below the user’s input content).

In this way, the editing interaction region allows the user to implement interaction by chatting and to generate the editing instruction by chatting, thereby improving operation experience.

In some embodiments, the first page may represent a writing page corresponding to an AI assisted writing tool. The editing instruction may be used to instruct the AI assisted writing tool to perform a certain editing operation on the document, such as a new addition, deletion, modification, movement, or copying operation.

In some embodiments, the method may further include:
dividing the document into at least one page element and generating a corresponding identifier for each page element.
Optionally, the steps of dividing the document and generating the identifier may be implemented in the process of the method. For example, when the document is opened and displayed in the first page, the steps of dividing the document and generating the identifier may be triggered, so as to make preparations for subsequent editing operations.

In some embodiments, considering that the user may only view the document without editing the document or may not have the editing permission, when an editing interaction operation is detected on the first page, the entire document may be analyzed and processed, and the document is split into at least one independent page element. The page element is a hyper text mark-up language (HTML) element.

The at least one page element may refer to a component in the document that may be independently identified and operated, such as each paragraph, title, picture, table, or each editable block or region. Through this division, the content of the document may be managed and operated more precisely.

After the document is divided into the at least one page element, a unique identifier may be generated for each page element. Optionally, the identifier may be a universally unique identifier (UUID), a number, an identity document (ID), or other unique marks.

The identifier may be used to distinguish different page elements, ensuring that each page element may be accurately located and tracked.

By generating the identifier for the page element, a specific page element may be accurately located, referenced, and operated through the identifier in subsequent operations, such as a new addition, deletion, modification, movement, or copying operation on a certain page element, or reusing and referencing the element between different pages.

The mechanism of automatically performing element division and identifier generation on the document based on the editing interaction operation of the user facilitates subsequent tracking and management, and helps improve the efficiency and flexibility of document management.

In some embodiments, the dividing the document into at least one page element may further include the following steps:
Step A1: performing semantic analysis on the document to obtain a semantic analysis result.
Step A2: dividing the document into the at least one page element based on the semantic analysis result.

In step A1, the AI assisted writing tool may perform semantic analysis on the document (that is, the document being edited by the user). The purpose of semantic analysis is to understand the content and structure of the document and extract key information therefrom, such as a paragraph theme, a sentence meaning, and an entity relationship.

The semantic analysis result may include information such as a hierarchical structure, a theme classification, and keyword extraction of the document. The semantic analysis result may be presented in the form of a data structure or visualization to help better understand the content of the document and provide a basis for subsequent operations. The data structure may be, for example, a tree diagram, a JavaScript object notation (JSON) object, or the like.

In step A2, the document may be divided into at least one page element based on the semantic analysis result. The page element may be understood as different parts or components in the document, such as a title, a paragraph, a picture, and a table.

This division is performed based on the semantic content of the document, rather than simple text segmentation. For example, a continuous text block is divided into a plurality of paragraphs or sections based on its theme or structure.

This processing manner facilitates smarter understanding and operation of the content of the document, improving the efficiency of editing and management.

In some embodiments, in step A1, the performing semantic analysis on the document to obtain a semantic analysis result may further include the following steps:
Step A11: performing text feature extraction on the document to obtain a text feature extraction result.
Step A12: performing sentence segmentation on the document based on the text feature extraction result to obtain a plurality of segmented sentences.
Step A13: determining semantic similarity between every two of the segmented sentences and performing merging processing on at least one of the segmented sentences with semantic similarity greater than a preset threshold to obtain at least one merged sentence, and using the at least one merged sentence as the semantic analysis result.

In some embodiments, in step A11, text feature extraction may be implemented based on natural language processing (NLP) to obtain a text feature extraction result.

The purpose of text feature extraction is to transform the text content in the document into a numerical value or a structured representation (such as a word vector) that may be processed by a computer.

The extracted text feature extraction result may include keywords, word frequency, syntax structure, semantic information, etc., for subsequent semantic analysis.

Then, in step A12, sentence segmentation may be performed on the document based on the text feature extraction result to obtain a plurality of segmented sentences. The sentence segmentation may be to split continuous text in the document into independent sentences or clauses based on a grammatical or semantic boundary (such as punctuation marks like a period, a question mark, and an exclamation mark).

Each segmented sentence may be processed individually, which facilitates subsequent semantic similarity calculation and merging.

After that, in step A13, semantic similarity between every two of the segmented sentences may be calculated, and the segmented sentences with semantic similarity greater than a preset threshold are merged to obtain at least one merged sentence as the semantic analysis result.

The semantic similarity is determined by comparing semantic features (such as word vectors, a topic model, and a syntax structure) of the sentences to determine their semantic similarity. For example, the similarity between two sentences may be calculated using cosine similarity, Euclidean distance, or the like.

If the semantic similarity between two or more sentences exceeds the preset threshold (for example, 0.8), it is considered that the content they express is highly correlated and may be merged into one sentence.

The purpose of merging is to reduce redundant information and retain core semantic content of the document.

The final merged sentence is the output of the semantic analysis of the document, representing the content that is highly correlated semantically in the document.

In some embodiments, step A2 may further include the following steps:
performing element decomposition on the document based on the at least one merged sentence to obtain the at least one page element.

In some embodiments, the content that is highly correlated semantically (that is, the at least one merged sentence) in each document may be for different data segments or page elements.

The document is disassembled into smaller independent parts, that is, page elements, based on the content that is highly correlated semantically in each document. The page element may be a paragraph, a picture, a table, a title, a list item, or the like in the document.

After element decomposition, the original cloud document is split into multiple independent and individually operable parts. These elements may be edited, moved, deleted, or recombined individually, so as to operate on some parts of the document individually, such as adjusting the format and moving the position.

In some embodiments, the dividing the document into at least one page element may further include the following steps:
Step B1: performing structural parsing on the document to obtain a structural parsing result.
Step B2: dividing the document into the at least one page element according to the structural parsing result.

In step B1, structural parsing may be performed on the document (that is, the document being edited by the user). The content and format of the cloud document are analyzed through the structural parsing, and structure information of the document is extracted, that is, the structural parsing result is obtained. For example: a hierarchical structure of the document (such as a title, a paragraph, and a list), a type of an element (such as text, a picture, a table, and a chart), and a relationship between the elements (such as a parent-child relationship and a sibling relationship).

The structural parsing result may be used to describe the composition and layout of the document, and is usually represented by a certain data structure (such as a tree structure and JSON).

Then, in step B2, the document may be split into a plurality of independent page elements based on the structural parsing result, which facilitates individual editing, operation, or rendering of each element. In addition, finer document management may be supported, such as format adjustment for a certain paragraph and replacement of a certain picture.

For example, as shown in FIG. 3, the AI assisted writing tool may divide the document displayed in the first page 300 into a plurality of page elements 302.

In some embodiments, in step B1, the performing structural parsing on the document to obtain a structural parsing result may further include the following steps:
Step B11: performing layout region detection on the document using an edge detection algorithm to obtain a plurality of layout regions; and
Step B12: classifying the plurality of layout regions based on display data in the plurality of layout regions to obtain a plurality of classification results, and using the plurality of classification results as the structural parsing result.

In some embodiments, the edge detection algorithm is used to identify regions in an image where brightness or color changes sharply, which usually correspond to object boundaries or text lines in the image. Optionally, the edge detection algorithm may include Canny edge detection, Sobel operator, Laplacian operator, etc.

By applying the edge detection algorithm, different layout regions in the document, such as text paragraphs, titles, pictures, tables, etc., may be identified and divided. These regions may be determined based on the distribution and pattern of edges in the image.

The display data in the plurality of layout regions may refer to specific information extracted from the detected layout regions, such as text content, picture features, and table structure.

Based on the display data, a classification algorithm (such as rule-based classification and a machine learning classifier) is used to classify each layout region. For example, a region containing a large amount of text is classified as a "text paragraph", a region containing a grid structure and numbers is classified as a "table", a region containing image pixel data is classified as a "picture", and so on.

After each layout region is classified, it will be given a corresponding classification label, and these labels together form the structural parsing result of the document, which provides a basis for subsequent document processing (such as information extraction and content analysis).

In some embodiments, step B2 may further include the following steps:
extracting the layout region corresponding to each of the classification results from the document to obtain the at least one page element.

In some embodiments, the classification result may refer to the result of classifying or labeling the content of the document. For example, the content in the document may be classified as a "title", a "paragraph", a "picture", a "table", etc.

The layout region may refer to a specific position or region occupied by each classification result in the document. For example, a "title" may be located at the top of the document, occupying a certain number of rows and columns; a "picture" may be located at a specific position in the document, occupying a certain number of pixels or spaces.

For each classification result (such as a "title" and a "paragraph"), its specific position or region in the document needs to be determined.

By extracting the layout region corresponding to each classification result from the document, a plurality of independent page elements are finally identified and sorted out from the document. These elements may be edited, moved, deleted, or recombined individually, so as to operate on some parts of the document individually, such as adjusting the format and moving the position.

Continuing to refer to FIG. 2, in step 202, update data and a target identifier may be determined in response to receiving an editing instruction from the editing interaction region.

In some scenarios, when the user performs an editing-related interaction action on the document on the first page, a series of subsequent operations will be triggered. The editing-related interaction action may generate the editing instruction, including but not limited to any behavior of changing, adding, and/or deleting the content of the document, such as the user inputting text, inserting a picture, drawing a graphic, and modifying a format.

In some embodiments, the editing interaction operation may be receiving the editing instruction for the document from the editing interaction region, so that the user may trigger the process of analyzing and processing the document by inputting the editing instruction in the editing interaction region, which facilitates the user's input of the editing interaction operation. Optionally, the editing interaction region may refer to an interface region where the user interacts with the cloud document, for example, an interface where the user interacts with the document through operations such as clicking, dragging, and inputting. When the user performs an operation in the editing interaction region, such as inputting text or voice information, the editing instruction is formed. The editing instruction may be used to instruct the AI assisted writing tool to perform a certain editing operation on the document, such as a new addition, deletion, modification, movement, or copying operation.

Optionally, the editing instruction may be generated based on content input in an input region of the editing interaction region, and the input content corresponding to the editing instruction and reply content generated based on the input content may be displayed in a conversation region of the editing interaction region, thereby implementing conversational interaction and improving experience.

In this step, the update data may refer to data corresponding to before and after the editing operation is performed on the document based on the editing instruction. Optionally, the corresponding update data may be determined based on the editing operation corresponding to the editing instruction. Furthermore, after the update data is determined, the target identifier corresponding to the update data may be determined, and the target identifier corresponds to at least one target page element of the document, so that positioning in the document may be implemented based on the update data.

In some embodiments, in step 202, the determining the update data and the target identifier may further include the following steps:
Step C1: acquiring first display data of the document at a current moment and second display data of the document at an immediate previous moment of the current moment.
Step C2: determining the update data based on the first display data and the second display data, and determining the target identifier corresponding to the update data.

In some embodiments, the first display data at the current moment may be data content presented to the user on a user interface (such as a browser and an application window) by the document at the current moment. This may include all visible elements such as text, format, pictures, and tables of the document.

The second display data at the immediate previous moment of the current moment may be data content presented to the user on the user interface by the document at the immediate previous moment. Similar to the first display data, it also contains all visible elements of the document, but may differ from the first display data due to the user’s editing, automatic updating of the document, or other reasons.

The purpose of acquiring the display data at the two time points is to compare changes of the document at different time points. For example, it is detected whether the document has been edited, the update of the document is monitored, and a version control or rollback function of the document is implemented.

As an exemplary scenario, assuming that the editing interaction operation on the document on the first page is to replace the text "AAAA" with "BBBB", the AI assisted writing tool may traverse "AAAA" in the document and replace them with "BBBB" in turn. It may be understood that the data including the replaced text "BBBB" may be considered as the first display data, and the data including the text "AAAA" before replacement may be the second display data. Here, the time nodes before and after the text replacement may be considered as the immediate previous moment and the current moment, respectively.

It should be noted that because the document may include a plurality of text records of "AAAA", the time nodes before and after each replacement may be considered as the immediate previous moment and the current moment, respectively, and the data corresponding to before and after each replacement may be considered as the second display data and the first display data. Here, for the purpose of illustration, only one replacement is used as an example to describe the specific implementation.

The above exemplary scenario is described only by using the replacement operation on the content of the document. It may be understood that when the editing interaction operation is another type of operation, the first display data and the second display data may be determined based on a same principle, which is not described herein again.

In some embodiments, by comparing the first display data with the second display data, the parts in the document that have changed may be identified. These changes may include addition and deletion of text, format adjustment, picture replacement, etc.

The update data is a sum of these changes, which reflects all modifications experienced by the document from the immediate previous moment to the current moment.

After the update data is determined, a corresponding target identifier needs to be determined for the updated content.

The target identifier is used to uniquely identify or track each update data, ensuring accurate tracking and verification of the updated content.

In some embodiments, step C2 may further include the following steps:
Step C21: searching for display data that is different between the first display data and the second display data and using the different display data as the update data.
Step C22: searching for an identifier corresponding to a position of the update data from a pre-built database to obtain the target identifier, where the database includes identifiers corresponding to different positions of the document.

In some embodiments, the first display data may be compared with the second display data to find out the differences between them. These differences may include addition, deletion, and modification of text, format changes, update of pictures or charts, etc.

Once the differences are found, these different parts are considered as the content that needs to be updated, that is, the update data.

The pre-built database contains a unique identifier for each position (or element) in the document. These identifiers are used to precisely locate specific content in the document, whether it is a text paragraph, a picture, a table, or another element.

Based on the position of the update data in the document, the corresponding identifier is searched for in the database. This identifier may uniquely identify the specific page element part involved in the update data.

The difference between the first display data and the second display data may be compared by using a tree structure-based difference (Diff) identification algorithm, to find out the differences between them.

The tree structure-based difference (Diff) identification algorithm may accurately locate the specific position where the change occurred and the change type (such as addition, deletion, modification, or movement) of the update data.

Based on the detected differences, a series of atomic operation instruction sets (Operations, Ops for short) are generated. Each atomic operation instruction in the atomic operation instruction set includes: an operation type, a target identifier, and related operation parameters, to form a complete incremental change description.

In step 203, the document page corresponding to the document may be controlled to move to the position corresponding to the target page element, and the target page element is edited based on the update data.

In some embodiments, each page element has a unique identifier (ID) corresponding to it, and these identifiers may be UUIDs, numbers, IDs, or other unique marks, which are used to distinguish different page elements.

All page elements in the current document are traversed, and by comparing the identifier of each element with the target identifier, the page element that matches the target identifier is found and used as the target page element.

Once the target page element is determined, its specific position on the page is calculated (for example, a pixel value from the top of the page).

Then, the document page (for example, the right region of the page 300 in FIG. 3) is controlled to move to that position to achieve a smooth transition, causing the target page element to appear within the user's visible range.

After moving to the target position, the user may see the target page element and the content around it.

The unique identifier is used to quickly locate the target, and automatic tracking of the edited content is implemented through the movement operation, thereby improving the user experience.

In some embodiments, after the document page is moved to the position corresponding to the target page element, the target page element may be edited based on the update data. For example, an editing process of the target page element based on the editing instruction may also be displayed in the document page.

As an example, assuming that the editing instruction for the document is to replace the text "AAAA" with "BBBB", step 203 may be to first move the first page to the position corresponding to "AAAA" and then display the editing process for "AAAA". Exemplarily, the editing process may be to first delete "AAAA" and then input "BBBB". In this way, after the document page is moved to the position corresponding to the target page element, the editing process of the target page element based on the editing instruction may also be displayed on the first page, so that the user may intuitively see the specific updating process of the document by the editing instruction, further improving the user experience.

Furthermore, a priority judgment algorithm may also be combined in the process of controlling the movement of the document page, which may intelligently decide to focus on the most critical change data first in the case where a plurality of pieces of change data are generated, ensuring that the user always pays attention to the most important content changes.

For example, as shown in FIG. 3, if the target page element corresponding to the current moment is the position pointed to by arrow 1, the document page is controlled to move to the position pointed to by arrow 1 to display the editing process and the updated document.

As shown in FIG. 4, if at the next moment of the current moment, the target page element is updated to the position pointed to by arrow 2, the document page is controlled to move from the position pointed to by arrow 1 to the position pointed to by arrow 2 to display the editing process and the updated document.

As shown in FIG. 5, if at the next two moments of the current moment, the target page element is updated to the position pointed to by arrow 3, the document page is controlled to move from the position pointed to by arrow 2 to the position pointed to by arrow 3 to display the editing process and the updated document.

In some embodiments, in step 203, the determining the update data and the target identifier may further include the following steps:
Step D1: comparing the target identifier with the identifier corresponding to each of the page elements to obtain an identifier that is the same as the target identifier.
Step D2: searching for the page element corresponding to the identifier that is the same as the target identifier from the at least one page element to obtain the target page element.

In some embodiments, the target identifier is compared with the identifier corresponding to each known page element on the first page one by one. This process may involve traversing a list or set that contains all page elements and their corresponding identifiers.

In the comparison process, an identifier that is exactly the same as the target identifier is searched for. Next, based on the matching identifier found, the corresponding page element is located and extracted from the plurality of page elements. This page element is the target that the user wants to operate on or obtain information from.

The target page element may be quickly located by comparing the target identifier with the identifier corresponding to each page element.

In some embodiments, after step 203, the method may further include the following steps:
displaying display data of a position corresponding to the target page element according to a preset display state.

In some embodiments, the preset display state refers to one or more display modes predefined for the page element. Optionally, the display state includes but is not limited to: highlighting, color, size, font, transparency, animation effects, etc.

The display data of the position corresponding to the target page element is displayed on the first web page according to the preset display state, to ensure that the page element may be presented to the user in the most appropriate way in different situations, so that the user may intuitively see the data updating process and timely know the position of the updated data content in the document without manual searching, thereby improving the writing efficiency.

In some embodiments, the first page includes a moving control.

After step 203, the method may further include the following steps:
Step E1: stopping movement of the document page and displaying a corresponding document page based on a viewing instruction in response to receiving the viewing instruction on the document page.
Step E2: controlling the document page to move to the position corresponding to the target page element in response to a triggering operation on the moving control.

In some embodiments, when the user performs a viewing operation on the document page (for example, the page is currently scrolling down, but the user swipes the document page up or clicks on any position on the current document page), the movement of the document page may be stopped and the corresponding document page is displayed based on the viewing instruction. For example, a corresponding position of the document page is displayed based on an upward swiping distance, or the document page is displayed based on the clicked position. Furthermore, the moving control is displayed on the first page at this time.

Then, when the user triggers the moving control on the first page (for example, clicks on a scroll bar, a button, or a sliding region), the moving control displayed on the document page is hidden at this time, and the document page is controlled to resume automatic movement in an original moving direction of the document page (for example, the page is currently moving down) until the position corresponding to the target page element (such as a specific title, paragraph, or content block) is reached.

The moving control is an interactive element (such as a scroll bar, a button, and a gesture region) in the first page for controlling the movement of the page. The automatic movement function of the first page may be quickly restored through the moving control.

For example, as shown in FIG. 5, if the automatic movement function is performed on the document page, the page is moving down. If the user wants to view the content above on his or her own, the user performs an upward movement operation by sliding the mouse on the document page. Then, the updated document is displayed based on an upward movement instruction, and the moving control 303 is displayed on the first page 300 at this time.

Then, when the user triggers the moving control 303 on the first page 300 (for example, clicks on a scroll bar, a button, or a sliding region), the moving control 303 displayed on the first page 300 is hidden at this time, and the document page is controlled to resume the original automatic downward automatic scrolling function until the position corresponding to the target page element (such as a specific title, paragraph, or content block) is reached, thereby quickly restoring the tracking function.

According to the above solution, when the editing instruction for the document is executed on the first page, the document is automatically divided into a plurality of page elements, and a corresponding unique identifier is generated for each page element, to facilitate subsequent tracking and management. Then, by determining the specific updated content and the corresponding target identifier thereof, the target page element is quickly located from the at least one page element based on the target identifier and the identifier corresponding to each page element, and the first page is controlled to automatically scroll to the position corresponding to the target page element, and the editing process and the updated document content are displayed in real time, to ensure that the user may intuitively see the data updating process and timely know the position of the updated data content in the document without manual searching, thereby improving the writing efficiency.

It should be noted that the method in the embodiments of the present application may be performed by a single device, such as a computer or a server. The method in this embodiment may also be applied in a distributed scenario and completed by a plurality of devices cooperating with each other. In the case of such a distributed scenario, one of the plurality of devices may perform only one or more steps of the method in the embodiments of the present application, and the plurality of devices may interact with each other to complete the method.

It should be noted that some embodiments of the present application are described above. Other embodiments are within the scope of the appended claims. In some cases, the actions or steps recited in the claims may be performed in an order different from that in the embodiments described above and still achieve desired results. Furthermore, the processes depicted in the drawings do not necessarily require a specific order shown or a sequential order to achieve desired results. In some implementations, multitasking and parallel processing are also possible or may be advantageous.

Based on the same inventive concept, the present application further provides a page content editing apparatus corresponding to the method in any one of the above embodiments.

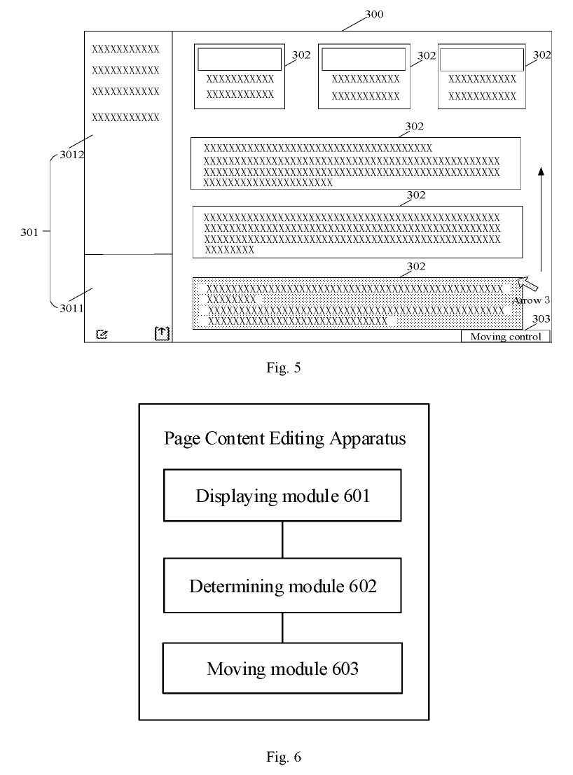

Referring to FIG. 6, the page content editing apparatus includes:
a displaying module 601, configured to display a first page, where the first page includes a document and an editing interaction region;
a determining module 602, configured to determine update data and a target identifier in response to receiving an editing instruction from the editing interaction region, where the target identifier corresponds to at least one target page element of the document; and
a moving module 603, configured to control a document page corresponding to the document to move to a position corresponding to the target page element and edit the target page element based on the update data.

In some embodiments, the editing interaction region is configured to implement interaction by a conversational manner;
the editing interaction region includes a conversation region and an input region, the editing instruction is generated based on content input in the input region, and the conversation region includes input content corresponding to the editing instruction and reply content generated based on the input content.

In some embodiments, the determining module 602 includes:
an acquiring unit, configured to acquire first display data of the document at a current moment and second display data of the document at an immediate previous moment of the current moment; and
an updating unit, configured to determine the update data based on the first display data and the second display data and determine the target identifier corresponding to the update data.
In some embodiments, the page content editing apparatus further includes a dividing module, configured to divide the document into at least one page element and generate a corresponding identifier for each of the page elements.

In some embodiments, the dividing module further includes:
a semantic parsing unit, configured to perform semantic analysis on the document to obtain a semantic analysis result in response to receiving an editing instruction for the document from the editing interaction region; and
a first dividing unit, configured to divide the document into the at least one page element based on the semantic analysis result.

In some embodiments, the semantic parsing unit is further configured to:
perform text feature extraction on the document to obtain a text feature extraction result;
perform sentence segmentation on the document based on the text feature extraction result to obtain a plurality of segmented sentences; and
determine semantic similarity between every two of the segmented sentences and perform merging processing on at least one of the segmented sentences with semantic similarity greater than a preset threshold to obtain at least one merged sentence, and use the at least one merged sentence as the semantic analysis result.

In some embodiments, the first dividing unit is further configured to:
perform element decomposition on the document based on the at least one merged sentence to obtain the at least one page element.

In some embodiments, the dividing module 602 includes:
a structural parsing unit, configured to perform structural parsing on the document to obtain a structural parsing result in response to receiving an editing instruction for the document from the editing interaction region; and
a second dividing unit, configured to divide the document into the at least one page element according to the structural parsing result.

In some embodiments, the structural parsing unit is further configured to:
perform layout region detection on the document using an edge detection algorithm to obtain a plurality of layout regions; and
classify the plurality of layout regions based on display data in the plurality of layout regions to obtain a plurality of classification results, and use the plurality of classification results as the structural parsing result.

In some embodiments, the second dividing unit is further configured to:
extract the layout region corresponding to each of the classification results from the document to obtain the at least one page element.

In some embodiments, the updating unit is further configured to:
search for different display data between the first display data and the second display data and use the different display data as the update data; and
search for an identifier corresponding to a position of the update data from a pre-built database to obtain the target identifier, where the database includes identifiers corresponding to different positions of the document.

In some embodiments, the moving module 603 is further configured to:
compare the target identifier with the identifier corresponding to each of the page elements to obtain an identifier that is the same as the target identifier; and
search for the page element corresponding to the identifier that is the same as the target identifier from the at least one page element to obtain the at least one target page element.

In some embodiments, the page content editing apparatus further includes a display state updating module. After the first page is controlled to scroll to the position corresponding to the target page element to display the editing process of the target page element and the updated document based on the editing instruction, the display state updating module is further configured to:
display display data of the position corresponding to the target page element according to a preset display state.

In some embodiments, the first page includes a moving control; and
the page content editing apparatus further includes a moving control module. After the first page is controlled to scroll to the position corresponding to the target page element to display the editing process of the target page element and the updated document based on the editing instruction, the moving control module is further configured to:
stop movement of the document page and display a corresponding document page based on a viewing instruction in response to receiving the viewing instruction on the document page; and
control the document page to move to the position corresponding to the target page element in response to a triggering operation on the moving control.

For ease of description, when described, the above apparatus is divided into various modules based on functions. Certainly, when the present application is implemented, the functions of the modules may be implemented in the same one or more pieces of software and/or hardware.

The apparatus in the above embodiment is configured to implement the corresponding page content editing method in any one of the above embodiments, and has the beneficial effects of the corresponding method embodiment, which are not repeated herein.

Based on the same inventive concept, the present application further provides an electronic device corresponding to the method in any one of the above embodiments, including a memory, a processor, and a computer program stored in the memory and executable by the processor, where the computer program, when executed by the processor, implements the page content editing method according to any one of the above embodiments.

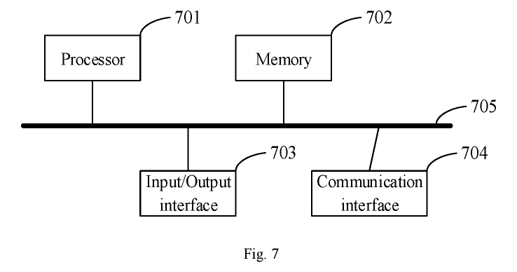

FIG. 7 shows a schematic diagram of a more specific hardware structure of an electronic device provided by this embodiment. The device may include: a processor 701, a memory 702, an input/output interface 703, a communication interface 704, and a bus 705. The processor 701, the memory 702, the input/output interface 703, and the communication interface 704 are communicatively connected to each other within the device through the bus 705.

The processor 701 may be implemented using a general-purpose central processing unit (CPU), a microprocessor, an application specific integrated circuit (ASIC), or one or more integrated circuits, etc., for executing related programs, to implement the technical solutions provided in the embodiments of the specification.

The memory 702 may be implemented in the form of a read-only memory (ROM), a random access memory (RAM), a static storage device, a dynamic storage device, etc. The memory 702 may store an operating system and other applications, and when the technical solutions provided in the embodiments of the specification are implemented by means of software or firmware, related program codes are stored in the memory 702 and called by the processor 701 for execution.

The input/output interface 703 is configured to connect to an input/output module to enable information input and output. The input/output module may be configured as a component in the device (not shown in the figure) or external to the device to provide a corresponding function. The input device may include a keyboard, a mouse, a touch screen, a microphone, various sensors, etc., and the output device may include a display, a speaker, a vibrator, an indicator light, etc.

The communication interface 704 is configured to connect to a communication module (not shown in the figure) to enable communication interaction between the device and other devices. The communication module may communicate in a wired (e.g., a USB, a network cable, etc.), or wireless (e.g., a mobile network, Wi-Fi, Bluetooth, etc.) manner.

The bus 705 includes a path for transferring information between the components (for example, the processor 701, the memory 702, the input/output interface 703, and the communication interface 704) of the device.

It should be noted that although only the processor 701, the memory 702, the input/output interface 703, the communication interface 704, and the bus 705 are shown in the device, during a specific implementation, the device may further include other components necessary for proper operation. Furthermore, it may be understood by those skilled in the art that the device may include only the components necessary to implement the solutions provided in the embodiments of the specification, and not necessarily include all of the components shown in the figure.

The electronic device in the above embodiment is configured to implement the corresponding page content editing method in any one of the above embodiments, and has the beneficial effects of the corresponding method embodiment, which are not repeated herein.

Based on the same inventive concept, the present application further provides a computer-readable storage medium corresponding to the method in any one of the above embodiments, where the computer-readable storage medium stores computer instructions, and the computer instructions are configured to cause a computer to execute the page content editing method according to any one of the above embodiments.

The computer-readable medium in this embodiment includes permanent and non-permanent, removable and non-removable media, in which information storage may be implemented by using any method or technology. Information may be computer-readable instructions, data structures, program modules, or other data. Examples of the computer storage medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a CD-ROM, a digital versatile disc (DVD), or other optical storage, a cassette tape, tape or disk storage or other magnetic storage devices, or any other non-transmission media, which may be used to store information capable of being accessed by a computing device.

The computer instructions stored in the storage medium of the above embodiment are configured to cause a computer to execute the page content editing method according to any one of the above embodiments, and have the beneficial effects of the corresponding method embodiment, which are not repeated herein.

Based on the same inventive concept, the present application further provides a computer program product corresponding to the method in any one of the above embodiments, including computer program instructions, where the computer program instructions, when executed on a computer, cause the computer to execute the method according to any one of the above embodiments, and have the beneficial effects of the corresponding method embodiment, which are not repeated herein.

It should be understood by those of ordinary skill in the art that the discussion of any one of the above embodiments is only exemplary, and is not intended to imply that the scope of the present application is limited to these examples; and with the concept of the present application, the technical features in the above embodiments or different embodiments may also be combined, the steps may be implemented in any order, and many other changes may be made to different aspects of the embodiments of the present application as described above and are not provided in detail for simplicity.

In addition, to simplify description and discussion and avoid obscuring an understanding of the embodiments of the present application, well-known power/ground connections to an integrated circuit (IC) chip and other components may or may not be shown in the drawings that are provided. Furthermore, the apparatus may be shown in the form of a block diagram to avoid obscuring an understanding of the embodiments of the present application, and the following fact is also taken into account: details regarding the implementation of the apparatus in the form of block diagram are highly dependent upon a platform on which the embodiments of the present application are to be implemented (i.e., such details should be fully understood by those skilled in the art). Where the specific details (e.g., circuitry) are set forth to describe the exemplary embodiments of the present application, it will be apparent to those skilled in the art that the embodiments of the present application may be implemented without these specific details or with variations to these specific details. These descriptions should therefore be considered illustrative rather than limiting.

Although the present application has been described with reference to the specific embodiments of the present application, many substitutions, modifications, and variations of these embodiments will be apparent to those of ordinary skill in the art from the foregoing description. For example, the discussed embodiments may be used for other memory architectures such as a dynamic RAM (DRAM).

The embodiments of the present application are intended to cover all such substitutions, modifications, and variations that fall within the broad scope of the present application. Therefore, any omissions, modifications, equivalent substitutions, improvements etc. made within the spirit and principle of the embodiments of the present application are intended to be included within the scope of protection of the present application.

1. A page content editing method, comprising:
displaying a first page, wherein the first page comprises a document and an editing interaction region;
determining update data and a target identifier in response to receiving an editing instruction from the editing interaction region, wherein the target identifier corresponds to at least one target page element of the document; and
controlling a document page corresponding to the document to move to a position corresponding to the at least one target page element and editing the at least one target page element based on the update data.

2. The method according to claim 1, wherein the editing interaction region is configured to implement interaction by a conversational manner;
wherein the editing interaction region comprises a conversation region and an input region; the editing instruction is generated based on content input in the input region, and the conversation region comprises input content corresponding to the editing instruction and reply content generated based on the input content.

3. The method according to claim 1, wherein determining the update data and the target identifier comprises:
acquiring first display data of the document at a current moment and second display data of the document at an immediate previous moment of the current moment; and
determining the update data based on the first display data and the second display data, and determining the target identifier corresponding to the update data.

4. The method according to claim 1, further comprising:
dividing the document into at least one page element and generating a corresponding identifier for each of the page elements.

5. The method according to claim 4, wherein dividing the document into at least one page element comprises:
performing semantic analysis on the document to obtain a semantic analysis result; and
dividing the document into the at least one page element based on the semantic analysis result.

6. The method according to claim 5, wherein performing semantic analysis on the document to obtain the semantic analysis result comprises:
performing text feature extraction on the document to obtain a text feature extraction result;
performing sentence segmentation on the document based on the text feature extraction result to obtain a plurality of segmented sentences; and
determining semantic similarity between every two of the segmented sentences and performing merging processing on at least one of the segmented sentences with semantic similarity greater than a preset threshold to obtain at least one merged sentence, and using the at least one merged sentence as the semantic analysis result.

7. The method according to claim 6, wherein dividing the document into at least one page element based on the semantic analysis result comprises:
performing element decomposition on the document based on the at least one merged sentence to obtain the at least one page element.

8. The method according to claim 4, wherein the dividing the document into at least one page element comprises:
performing structural parsing on the document to obtain a structural parsing result; and
dividing the document into the at least one page element according to the structural parsing result.

9. The method according to claim 8, wherein performing structural parsing on the document to obtain the structural parsing result comprises:
performing layout region detection on the document by using an edge detection algorithm to obtain a plurality of layout regions; and
classifying the plurality of layout regions based on display data in the plurality of layout regions to obtain a plurality of classification results, and using the plurality of classification results as the structural parsing result.

10. The method according to claim 9, wherein dividing the document into the at least one page element according to the structural parsing result comprises:
extracting the layout region corresponding to each of the classification results from the document to obtain the at least one page element.

11. The method according to claim 3, wherein the determining the update data based on the first display data and the second display data and determining the target identifier corresponding to the update data comprises:
searching for different display data between the first display data and the second display data and using the different display data as the update data; and
searching for an identifier corresponding to a position of the update data from a pre-built database to obtain the target identifier, wherein the database comprises identifiers corresponding to different positions of the document.

12. The method according to claim 4, wherein determining the update data and the target identifier comprises:
comparing the target identifier with the corresponding identifier to each of the page elements respectively to obtain an identifier that is the same as the target identifier; and
searching for the page element corresponding to the identifier that is the same as the target identifier from the at least one page element to obtain the at least one target page element.

13. The method according to claim 1, wherein after controlling a document page corresponding to the document to move to a position corresponding to the at least one target page element and editing the at least one target page element based on the update data, the method further comprises:
displaying display data of the position corresponding to the target page element according to a preset display state.

14. The method according to claim 1, wherein the first page comprises a moving control; and
after the document page corresponding to the document is controlled to move to the position corresponding to the at least one target page element and the at least one target page element is edited based on the update data, the method further comprises:
in response to receiving a viewing instruction on the document page, stopping movement of the document page, and displaying a corresponding document page based on the viewing instruction; and
in response to a triggering operation on the moving control, controlling the document page to move to the position corresponding to the target page element.

15. An electronic device, comprising a memory, a processor, and a computer program stored on the memory and executable by the processor, wherein the computer program, when executed by the processor, implements the method according to claim 1.

16. The electronic device according to claim 15, wherein the editing interaction region is configured to implement interaction by a conversational manner;
wherein the editing interaction region comprises a conversation region and an input region; the editing instruction is generated based on content input in the input region, and the conversation region comprises input content corresponding to the editing instruction and reply content generated based on the input content.

17. The electronic device according to claim 15, wherein determining the update data and the target identifier comprises:
acquiring first display data of the document at a current moment and second display data of the document at an immediate previous moment of the current moment; and
determining the update data based on the first display data and the second display data, and determining the target identifier corresponding to the update data.

18. A non-transitory computer-readable storage medium, storing computer instructions, wherein the computer instructions are configured to cause a computer to execute the method according to claim 1.

19. The non-transitory computer-readable medium, wherein the editing interaction region is configured to implement interaction by a conversational manner;
wherein the editing interaction region comprises a conversation region and an input region; the editing instruction is generated based on content input in the input region, and the conversation region comprises input content corresponding to the editing instruction and reply content generated based on the input content.

20. The non-transitory computer-readable medium, wherein determining the update data and the target identifier comprises:
acquiring first display data of the document at a current moment and second display data of the document at an immediate previous moment of the current moment; and
determining the update data based on the first display data and the second display data, and determining the target identifier corresponding to the update data.
